(19) United States
(12) Patent Application Publication
(10) Pub. No.: US 2008/0206497 A1
(43) Pub. Date: Aug. 28, 2008

(54) METHOD OF MANUFACTURING SLEEVE FOR FLUID-DYNAMIC BEARING AND SLEEVE MANUFACTURED BY THE METHOD

(75) Inventors: Shouji Hachiga, Fukushima (JP); Yoshihiro Shina, Tokyo (JP)

Correspondence Address: DRINKER BIDDLE & REATH (DC), 1500 K STREET, N.W., SUITE 1100, WASHINGTON, DC, 20005-1209, US

(73) Assignee: JUKI CORPORATION, Tokyo (JP)

(21) Appl. No.: 12/037,415

(22) Filed: Feb. 26, 2008

(30) Foreign Application Priority Data
Feb. 27, 2007 (JP) 2007-047043

(51) Int. Cl. C04B 35/64; B29D 22/00; B28B 1/30

(52) U.S. Cl. 428/34.5; 264/635

(57) ABSTRACT

A sleeve for a fluid-dynamic bearing is manufactured by molding to obtain a molded part, degreasing the molded part to obtain a degreased part, and sintering the degreased part. The molding includes placing a resin core having protrusions on an outer circumference thereof for transferring and forming dynamic-pressure generating grooves on the sleeve into a mold having a cavity corresponding to a shape of the sleeve, and injecting a molding material prepared by mixing a binder and metal or ceramic powders. The degreasing includes preparatory degreasing the molded part to remove a portion of the binder, and further degreasing the molded part, from which the portion of the binder is removed, by heating the molded part in a sintering furnace to thermally decompose the residual portion of the binder and the core. The sintering includes further heating the degreased part to sinter the metal powders or the ceramic powders.

### CROSS-REFERENCE TO RELATED APPLICATION(S)

The present application claims priority from Japanese Patent Application No. 2007-047043 filed on Feb. 27, 2007, the entire content of which is incorporated herein by reference.

### FIELD OF THE INVENTION

The present invention relates to a method of manufacturing a sleeve for a fluid-dynamic bearing, and a sleeve, which is manufactured by the method, having a bearing surface formed with dynamic-pressure generating grooves to support a rotating shaft.

### DESCRIPTION OF RELATED ART

A sleeve for a dynamic-pressure bearing has an inner circumferential surface formed with dynamic-pressure generating grooves. When a shaft inserted in the sleeve rotates, the dynamic-pressure generating grooves generate a dynamic pressure to a fluid between the shaft and the sleeve, thereby supporting the shaft in a radial direction with respect to the sleeve.

In a related art method of forming dynamic-pressure generating grooves on an inner surface of a sleeve, a cylindrical molded part is formed by compression-molding a powder material, and at the same time, the dynamic-pressure generating grooves are formed by transferring protrusions on a core rod corresponding to the dynamic-pressure generating grooves to the inner surface of the cylindrical molded part (see, e.g., JP 10-306827A).

In another related art method of forming dynamic-pressure generating grooves on a bearing surface, a shaft-shaped jig having balls, which are harder than a bearing work and are circumferentially arranged at regular intervals, is inserted into the bearing work while applying helical motions to the balls by rotating and feeding the jig, thereby pressing the balls onto an inner surface of the bearing work to plastically process a region where the dynamic-pressure generating grooves are to be formed (see, e.g., JP 2541208B2).

However, the method disclosed in JP 10-306827A has a following disadvantage.

That is, because a springback of the work allows an extraction of the core rod having the protrusions corresponding to the dynamic-pressure generating grooves, a depth of the dynamic-pressure generating grooves to be formed depends on an amount of the springback, e.g., the depth being a few tens of μm. Therefore, the method can only be applied for a bearing having a small diameter of 10 mm φ or less, and is unsuitable for such a radially large bearing as used in sewing machines.

Further, according to the method disclosed in JP 2541208B2, a pattern of the dynamic-pressure generating grooves are limited to a helical shape or a combination of helical shapes. Thus, the dynamic-pressure generating grooves cannot be freely designed to have an ideal pattern. Moreover, because raised portions are produced on respective sides of the dynamic-pressure generating grooves due to Poisson's deformation during the pressing of the balls to form the dynamic-pressure generating grooves, it is necessary to remove the raised portions by means of a lathe or a reamer. In addition, a further processing is required to remove secondary burrs produced by such a secondary processing.

### SUMMARY OF THE INVENTION

One or more exemplary embodiments of the present invention provide a method of accurately manufacturing a sleeve for a fluid-dynamic bearing with a small number of steps and without a limitation on a size of the sleeve, the sleeve having a dynamic-pressure generating surface with a freely designed three-dimensional shape.

According to one or more exemplary embodiments of the invention, a sleeve for a fluid-dynamic bearing is manufactured by molding to obtain a molded part, degreasing the molded part to obtain a degreased part, and sintering the degreased part. The molding includes placing a cylindrical core, which is made of a resin and having protrusions on an outer circumference thereof for transferring and forming dynamic-pressure generating grooves on the sleeve, into a mold having a cavity corresponding to a shape of the sleeve, and injecting a molding material prepared by mixing a binder and metal or ceramic powders. The degreasing includes preparatory degreasing the molded part to remove a portion of the binder, and further degreasing the molded part, from which the portion of the binder is removed, by heating the molded part in a sintering furnace to thermally decompose and to remove the residual portion of the binder and the core. The sintering includes further heating the degreased part to sinter the metal powders or the ceramic powders.

Other aspects and advantages of the invention will be apparent from the following description, the drawings and the claims.

### BRIEF DESCRIPTION OF THE DRAWINGS

FIG. 1A is a sectional view of a sleeve of a herringbone type dynamic-pressure bearing according to an exemplary embodiment of the invention;

FIG. 1B is a side view of the sleeve of the herringbone type dynamic-pressure bearing;

FIG. 2 is a flow chart of a method of manufacturing a sleeve for a fluid-dynamic bearing according to an exemplary embodiment of the invention;

FIG. 5A is a front view of a core;

FIG. 3B is a side view of the core;

FIG. 4 is an explanatory view showing an inner side of a mold for a metal injection-molding with the core being inserted therein;

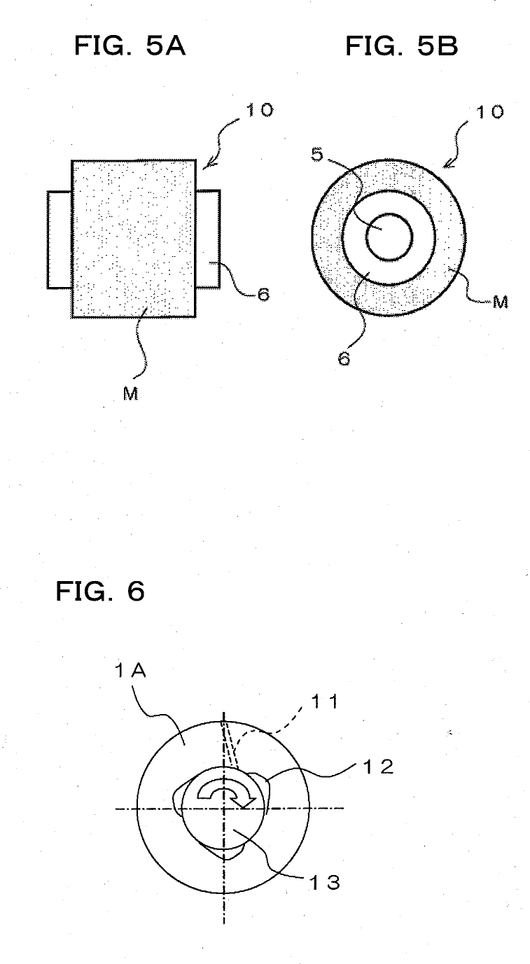

FIG. 5A is a front view of a molded part formed by the metal injection-molding with the core remaining therein;

FIG. 5B is a side view of the molded part formed by the metal injection-molding with the core remaining therein; and

FIG. 6 is a sectional view showing a sleeve of a tri-arc dynamic-pressure bearing manufactured by the method according to an exemplary embodiment of the invention.

### DETAILED DESCRIPTION

Hereinafter, exemplary embodiments of the invention will be explained with reference to the drawings. The following exemplary embodiments do not limit the scope of the invention.

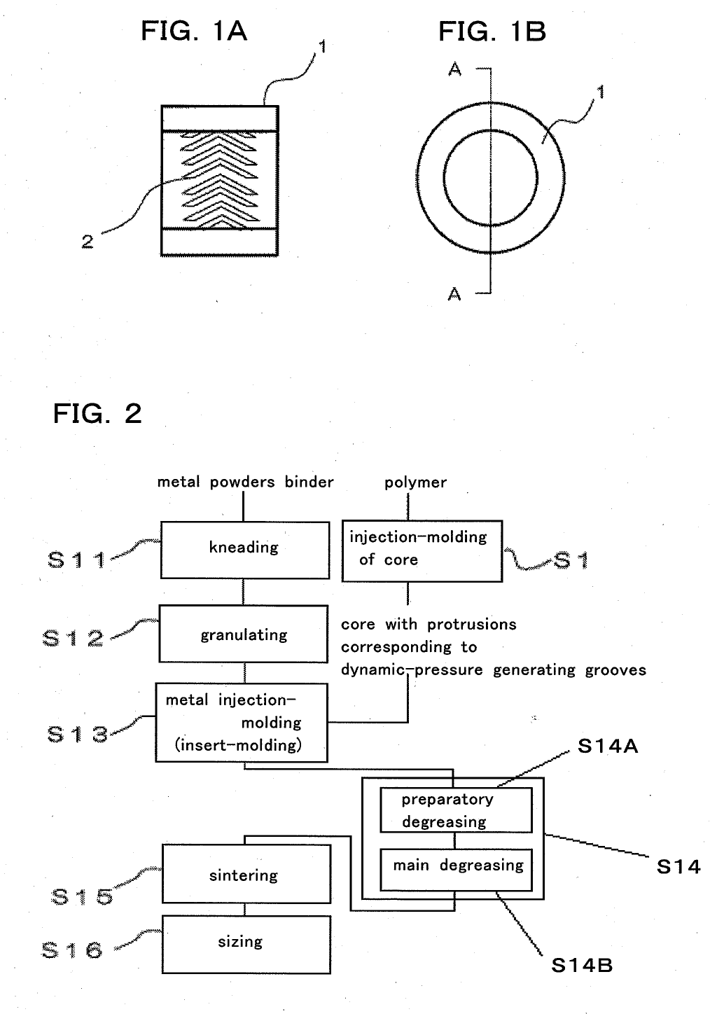

FIG. 1A and FIG. 1B show a sleeve 1 of a fluid-dynamic bearing (hereinafter “bearing sleeve 1”), which is manufactured by the method according to an exemplary embodiment of the invention. FIG. 1A is a sectional view taken along the line A-A of FIG. 1.

The bearing sleeve 1 has an inner surface formed with dynamic-pressure generating grooves 2 in a herringbone pattern consisting of a combination of lines that are slanted with respect to an axial direction. In the related art molding methods, it has been impossible to or difficult to form such a herringbone patterned dynamic-pressure generating grooves. When a shaft is inserted through the bearing sleeve 1 and is rotated, a lubricant (e.g., a grease) between the bearing sleeve 1 and the shaft is guided along the dynamic-pressure generating grooves 2 toward respective sharp-pointed portions thereof; whereby a frictional force between the bearing sleeve 1 and the shaft is reduced while keeping the bearing sleeve 1 and the shaft in a noncontact state.

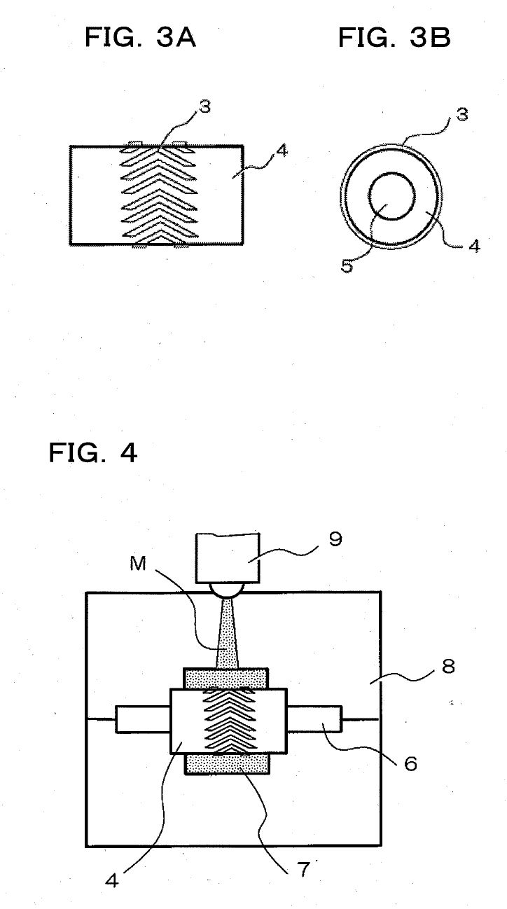

A method of manufacturing the sleeve 1 for a fluid-dynamic bearing according to an exemplary embodiment will described below with reference to the flow chart shown in FIG. 2.

First of all, as shown in FIG. 3, a cylindrical core 4 is provided by a plastic injection-molding (SI). The core 2 has protrusions 3 on an outer circumference thereof for transferring its pattern to form the herringbone shaped dynamic-pressure generating grooves 2. The core 4 may be formed by a thermoplastic resin such as POM (polyacetal), or a thermoset resin based on a phenol resin, an epoxy resin, or a diarylphthalate resin. The core 4 has a hollow portion 5 extending in the axial direction of the core 4. This hollow structure allows an efficient convection of an inert gas against the core 4 and facilitates thermal decomposition before sintering (S15).

In order to form the bearing sleeve 1 by an MIM (Metal Injection Molding), firstly, fine metal powders (e.g., steel powder) and a binder including plastic pellets of high-molecular compound (polymer) and a wax component are heated and kneaded (S11), and are granulated (S12) by a granulator to prepare a raw material M for the metal injection-molding.

Subsequently, as shown in FIG. 4, a core bar 6 is inserted into the hollow portion 5 of the core 4, and is then placed inside a metal injection mold 8. The mold 8 has a cavity 7, a shape which corresponding to the bearing sleeve 1. The material M, which is a mixture of the metal powder and the binder, is injected at 150° C. to 180° C. from an injection nozzle 9 into the cavity 7 (S13: molding), and is then extracted from the mold 8 after an instantaneous cooling and the core bar 6 is pulled out. After a gate cutting or a deburring if necessary, a metal molded part 10 as shown in FIG. 5, so-called “green”, is obtained.

Then, the metal molded part 10 is subjected to such a preparatory degreasing that a shape thereof can be maintained, whereby a degreased part, so-called “brown”, is obtained. More specifically, the metal molded part 10 is subjected to a heat degreasing or a solvent degreasing through, e.g., normal hexane, in order to remove only the wax component of the binder (S14A: a preparatory degreasing). In a case of performing the preparatory degreasing by the heat degreasing, a temperature in which the heating is performed is equal to or higher than a thermal decomposition temperature of the wax component but lower than a thermal decomposition temperature of the polymer.

Subsequently, the degreased part is placed inside a sintering furnace (not shown), and is heated to a temperature that is equal to or higher than the thermal decomposition temperature of the polymer (e.g., heated to 650° C.) with the inert gas such as nitrogen or argon, and a reducing gas such as hydrogen, thereby thermally decomposing the polymer, which is the residual component of the binder, together with the core 4 which is made of resin (polymer). The polymer is completely gasified, and is discharged outside the sintering furnace via a vacuum pump (S14B: a main degreasing). A degreasing step (S14) includes this main degreasing step and the aforementioned preparatory degreasing step.

Next, the degreased part is heated to a temperature at which the metal powder component is sintered, whereby a sintered part, so-called “silver”, is obtained (S15: a sintering).

Thereafter, a precise sizing may be performed by a surface treatment or a further thermal treatment if necessary, and the bearing sleeve 1 having a desired shape and high density is formed (S16).

In a case where iron group metal, e.g., an SCM (chromium-molybdenum steel), an SNCM (nickel-chromium-molybdenum steel), or an SUS (stainless steel) material is used as the metal powders, a necking is caused among the metal powders at about 900° C. and the metal powders starts to be bonded with each others and the metal powers are sintered by heating up to about 1000° C. to about 1400° C., whereby a bearing sleeve 1 having a density of about 80% to about 100% can be obtained. The metal powders may also be copper group alloy powders. Moreover, ceramic powders may be used instead of the metal powders, and the molded part may be formed by a ceramic injection-molding. A bearing sleeve 1 having a high density can also be formed with such modifications.

According to the above exemplary embodiment, because the core 4 is removed by heating before the sintering of the bearing sleeve 1, it is not necessary to consider the pulling out of the core 4 from the sintered part, i.e. from the sintered bearing sleeve 1. Moreover, the dynamic-pressure generating grooves 2 can be freely designed to have any three-dimensional shape without limitation of a size. Therefore, the dynamic-pressure generating grooves 2 of complicated groove patterns can be easily formed on the inner surface of the bearing sleeve 1.

For example, although the above exemplary embodiment has been described in relation to the bearing sleeve 1 having the herringbone patterned dynamic-pressure generating grooves 2, the pattern of the dynamic-pressure generating grooves 2 is not be limited to the herringbone pattern. FIG. 6 shows a sleeve 1A of a tri-arc dynamic-pressure bearing and a shaft 13 inserted therein. The sleeve 1A has wedge portions 12, in which grease supplied from an oil feed port 11 is reserved, at three portions on an inner circumference thereof. This bearing sleeve 1A can also be manufactured by the method according to the exemplary embodiment with high dimensional accuracy.

According to the exemplary embodiment, moreover, because the dynamic-pressure generating grooves 2 can be formed with an excellent dimensional accuracy by removing the core 4 simultaneously with or before the sintering, it is possible to avoid an additional processing for removing secondary burrs which are produced by a secondary treatment. Thus, a postprocessing can be simplified, and the number of steps required is less than those in the related art methods. Accordingly, it is possible to reduce manufacturing cost.

Further, the bearing sleeve 1 manufactured by the method according to the exemplary embodiment has a bearing surface with a high molding accuracy, even if the dynamic-pressure generating grooves 3 are freely designed to have complex patterns. Thus, a proper circulation of a lubricant (e.g., a grease) can be ensured between the shaft and the bearing sleeve 1. Therefore, the bearing sleeve 1 having stable bearing function and high durability can be provided.

The method according to the exemplary embodiment is especially advantageous when manufacturing a sleeve of a fluid-dynamic bearing for a relatively large apparatus such as an industrial sewing machine. According to the manufactured sleeve of a fluid-dynamic bearing, a higher speed and a lower noise can be achieved as compared with the related art metal bearings.

While description has been made in connection with exemplary embodiments of the present invention, those skilled in the art will understand that various changes and modification may be made therein without departing from the present invention. It is aimed, therefore, to cover in the appended claims all such changes and modifications falling within the true spirit and scope of the present invention.

What is claimed is:

1. A method of manufacturing a sleeve for a fluid-dynamic bearing, the method comprising:
molding to obtain a molded part;
degreasing the molded part to obtain a degreased part; and
sintering the degreased part
wherein the molding comprises:
placing a cylindrical core, which is made of a resin and having protrusions on an outer circumference thereof for transferring and forming dynamic-pressure generating grooves on the sleeve, into a mold having a cavity corresponding to a shape of the sleeve; and
injecting a molding material prepared by mixing a binder and metal or ceramic powders
wherein the degreasing comprises:
preparatory degreasing the molded part to remove a portion of the binder; and
further degreasing the molded part, from which the portion of the binder is removed, by heating the molded part in a sintering furnace to thermally decompose and to remove the residual portion of the binder and the core,
wherein the sintering comprises further heating the degreased part to sinter the metal powders or the ceramic powders.

2. The method according to claim 1, wherein the preparatory degreasing comprises removing a wax component of the binder from the molded part, and wherein the further degreasing comprises heating to a temperature that is equal to or higher than a thermally decomposing temperature of a polymer component of the binder to thermally decompose and to remove the polymer component and the core.

3. The method according to claim 2, wherein the core is made of a polymer and comprises a hollow portion.

4. The method according to claim 2, wherein the preparatory degreasing comprises heating degreasing.

5. The method according to claim 2, wherein the preparatory degreasing comprises solvent degreasing.

6. A sleeve for a fluid-dynamic bearing manufactured by the method according to claim 1.
